(19) United States
(12) Patent Application Publication
(10) Pub. No.: US 2013/0169529 A1
(43) Pub. Date: Jul. 4, 2013

(54) ADJUSTING AN OPTICAL GUIDE OF A THREE-DIMENSIONAL DISPLAY TO REDUCE PSEUDO-STEREOSCOPIC EFFECT

(71) Applicant: Martin Ek, Dalby (SE)

(72) Inventor: Martin Ek, Dalby (SE)

(73) Assignee: SONY ERICSSON MOBILE COMMUNICATIONS AB, Lund (SE)

(21) Appl. No.: 13/823,263

(22) PCT Filed: Mar. 23, 2011
(86) PCT No.: PCT/IB2011/051240

§ 371 Date: Mar. 14, 2013

(51) Int. Cl. G02B 27/00

(52) U.S. Cl. CPC G02B 27/0093
USPC 345/156; 345/697

(57) ABSTRACT

A device may include sensors, a display, an optical guide, and one or more processors. The sensors may obtaining tracking information associated with a user. The display may include pixels for displaying images. The optical guide may include optical elements, each of the optical elements directing light rays from one or more of the pixels. In addition, the one or more processors may be configured determine a relative location of the user based on the tracking information obtained by the sensors, obtain values for control variables that are associated with the optical elements based on the relative location of the user, display a stereoscopic image via the display, and control the optical elements based on the values to direct the stereoscopic image to the relative location and to prevent a pseudo-stereoscopic image from forming at the relative location.

### BACKGROUND

A three-dimensional (3D) display may provide a stereoscopic effect (e.g., an illusion of depth) by rendering two slightly different images, one image for the right eye (e.g., a right-eye image) and the other image for the left eye (e.g., a left-eye image) of a viewer. When each of the eyes sees its respective image on the display, the viewer may perceive a stereoscopic image.

### SUMMARY

According to one aspect, a method may include determining a position of a user relative to a display of a device to obtain position information, wherein the device includes the display and an optical guide, wherein the display includes pixels for displaying images, and wherein the optical guide includes optical elements for directing light rays from the pixels. The method may also include selecting values for control variables associated with controlling the optical elements based on the position information and displaying a stereoscopic image at the display. The method may further include controlling the optical elements to send light rays from the pixels of the display to convey the stereoscopic image to the position of the user and to prevent a pseudo-stereoscopic image from forming at the position of the user, by setting the control variables to the selected values.

Additionally, selecting the values may include for each of the optical elements, selecting a horizontal displacement, relative to the display, of the optical element, or may include, for the optical elements, selecting a horizontal displacement relative to the display.

Additionally, the optical elements may include at least one of a parallax barrier element, a prism element, a grating element, or a lenticular lens element.

Additionally, selecting the values may includes: for each of the optical elements, selecting values for controlling micro-electromechanical system (MEMS) component, a muscle wire, memory alloys, a piezoelectric component, or controllable polymer to rotate or translate the optical element.

Additionally, selecting the values may include selecting values for setting optical properties of at least one of the optical elements, or selecting a value for setting optical properties of the optical elements.

Additionally, each of the optical elements may include at least one of a parallax barrier element, a lenticular lens element, a prism element, or a grating element.

Additionally, the stereoscopic image may include a right-eye image and a left-eye image. In addition, controlling the optical elements may include directing the right-eye image to the right-eye of the user during a first time interval and directing the left-eye image to the left-eye of the user during a second time interval following the first time interval.

Additionally, the method may further include determining a second position of a second user relative to the display to obtain second position information, displaying a second stereoscopic image at the display concurrently with the stereoscopic image, and controlling the optical elements to send light rays from the pixels of the display to convey the second stereoscopic image to the second position of the second user.

Additionally, selecting the values may include determining values for the control variables associated with the optical elements to change relative power associated with the stereoscopic image in relation to power associated with the pseudo-stereoscopic image at the determined position of the user.

Additionally, determining the values may include evaluating a ratio of the power associated with the stereoscopic image to the power associated with the pseudo-stereoscopic image at the position of the user, or looking up a table of values of the control variables, wherein the values are pre-computed based on ratios of the power associated with the stereoscopic image to the power associated with the pseudo-stereoscopic image.

Additionally, looking up may include identifying the values for the control variables based on the position of the user and an identifier associated with an optical element.

According to another aspect, a device may include sensors for obtaining tracking information associated with a user, a display including pixels for displaying images, and an optical guide including optical elements, each of the optical elements directing light rays from one or more of the pixels. The device may also include one or more processors to determine a relative location of the user based on the tracking information obtained by the sensors, obtain values for control variables that are associated with the optical elements based on the relative location of the user, display a stereoscopic image via the display, and control the optical elements based on the values to direct the stereoscopic image to the relative location and to prevent a pseudo-stereoscopic image from forming at the relative location.

Additionally, the sensors may include at least one of a gyroscope; a camera; a proximity sensor; or an accelerometer.

Additionally, the device may include a tablet computer, a cellular phone, a personal computer, a laptop computer, a camera, or a gaming console.

Additionally, the optical elements may include at least one of a parallax barrier element, a lenticular lens element, a prism element; or a grating element.

Additionally, the control variables may include at least one of an angle associated with one or more of the optical elements, a horizontal or vertical displacement associated with one of the optical elements, or a numerical value indicative of an optical property associated with one of the optical elements.

Additionally, the stereoscopic image may include a right eye image and a left-eye image at a right-eye position and a left-eye position that are associated with the relative location, respectively, and the pseudo-stereoscopic image may include one of a left-eye image or a right-eye image at the right-eye position and the left-eye position, respectively.

Additionally, when the one or more processors obtain the values for the control variables, the one or more processors may be further configured to at least one of evaluate a ratio of power contributed via one of the optical elements in forming the stereoscopic image to power contributed via the one of the optical elements in forming the pseudo-stereoscopic image, or to perform a look up of a table of control values that are computed based on ratios, each ratio indicative of relative contributions, via one of the optical elements, to the stereoscopic images and the pseudo-stereoscopic image at the relative location.

Additionally, one of the optical elements may include a micro-electromechanical system (MEMS) component, a muscle wire, memory alloys, a piezoelectric component, or controllable polymer for modifying a location or orientation of the one of the optical elements

According to yet another aspect, a device may include sensors for providing tracking information associated with a user, a display including pixels, and a parallax barrier including parallax barrier elements, each of the parallax barrier elements for guiding light rays from one or more of the pixels to a right eye or a left eye of a user. The device may also include one or more processors to determine a relative location of the user based on the tracking information, obtain values of control variables for each of the parallax barrier elements based on the relative location of the right eye and the left eye, display a stereoscopic image via the display, the stereoscopic image comprising a right-eye image and a left-eye image, and change a displacement of the one or more of the parallax barrier elements relative to the display, based on the values to direct the right-eye image to the right eye and prevent light rays from the right-eye image from reaching the left eye.

### BRIEF DESCRIPTION OF THE DRAWINGS

The accompanying drawings, which are incorporated in and constitute a part of this specification, illustrate one or more embodiments described herein and, together with the description, explain the embodiments. In the drawings:

FIG. 1A is a diagram of an exemplary three-dimensional (3D) system in which concepts described herein may be implemented;

FIG. 1B illustrates generation of a pseudo-stereoscopic image in the system of FIG. 1A;

FIGS. 2A and 3B are front and rear views of one implementation of an exemplary device of FIG. 1A;

FIG. 3 is a block diagram of components of the exemplary device of FIG. 1A;

FIG. 4 is a block diagram of exemplary functional components of the device of FIG. 1A;

FIGS. 5A and 5B illustrate exemplary operation of the optical guide of the device of FIG. 1A according to one embodiment;

FIGS. 6A and 6B illustrate exemplary operation of the optical guide of the device of FIG. 1A according to another embodiment;

FIGS. 7A through 7C illustrate different ways in which an optical element of

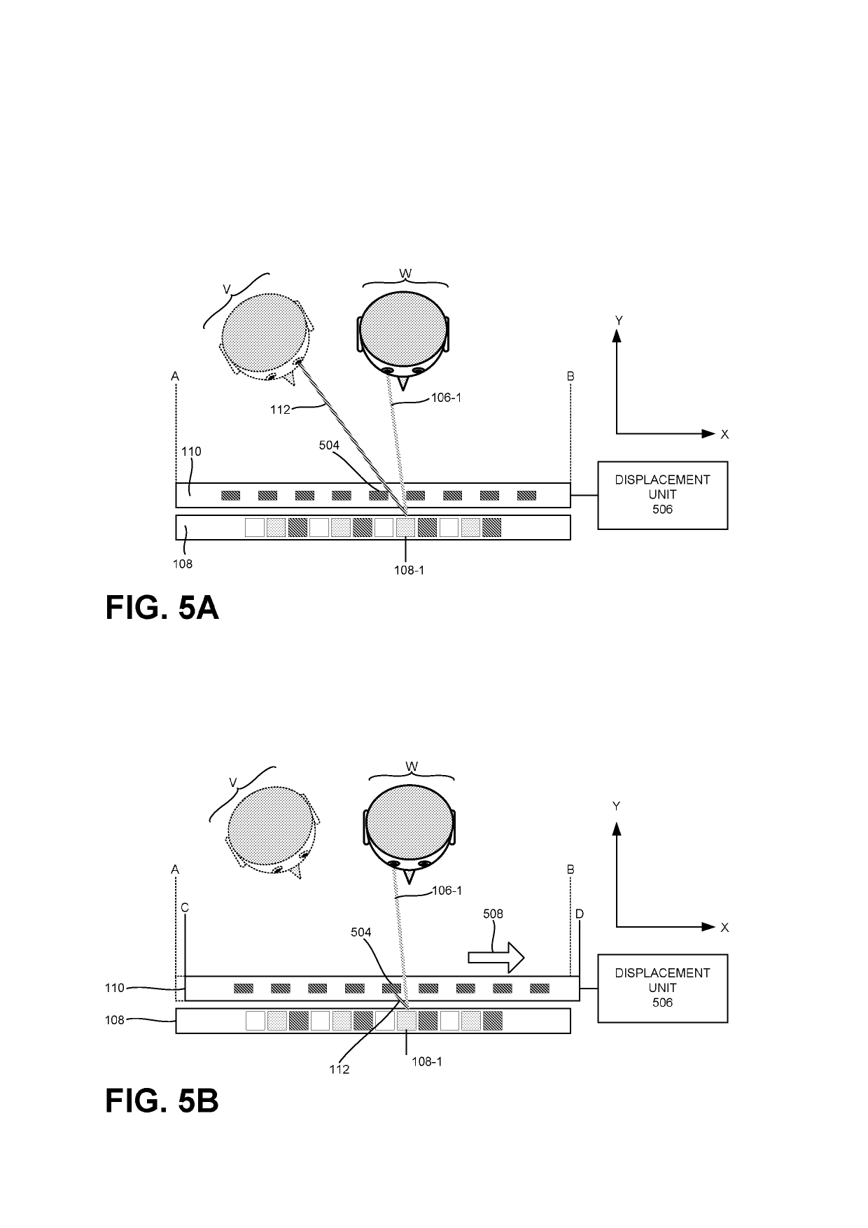

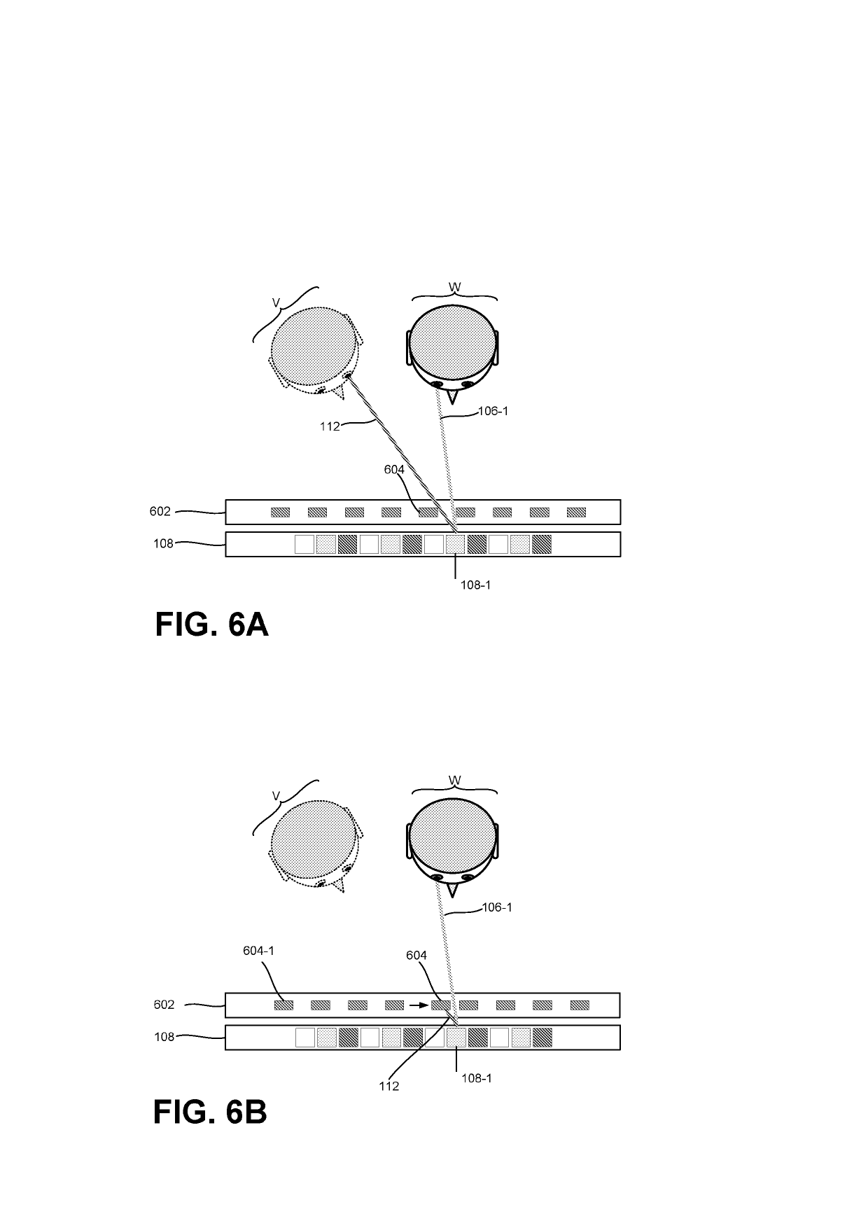

FIGS. 6A and 6B may move to modify the direction of light rays from the display of FIGS. 5A, 5B, 6A and 6B;

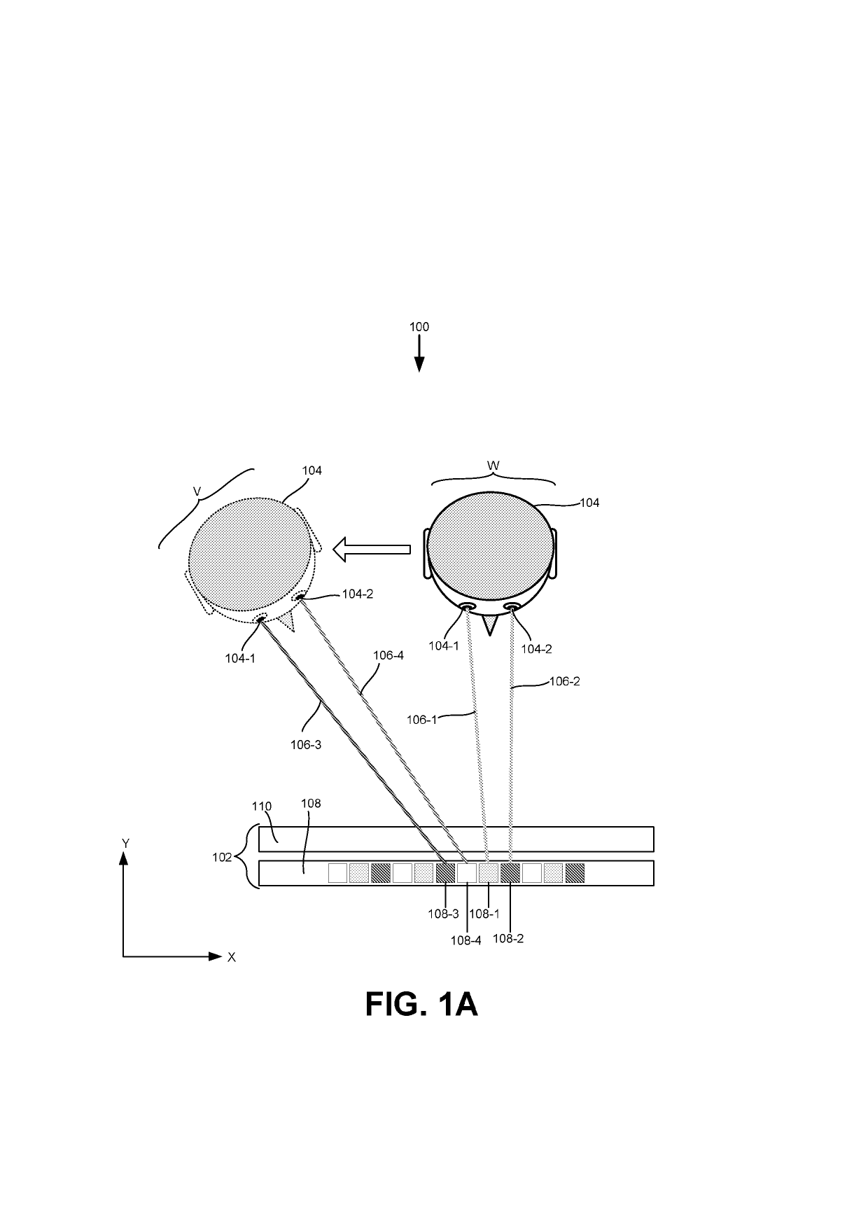

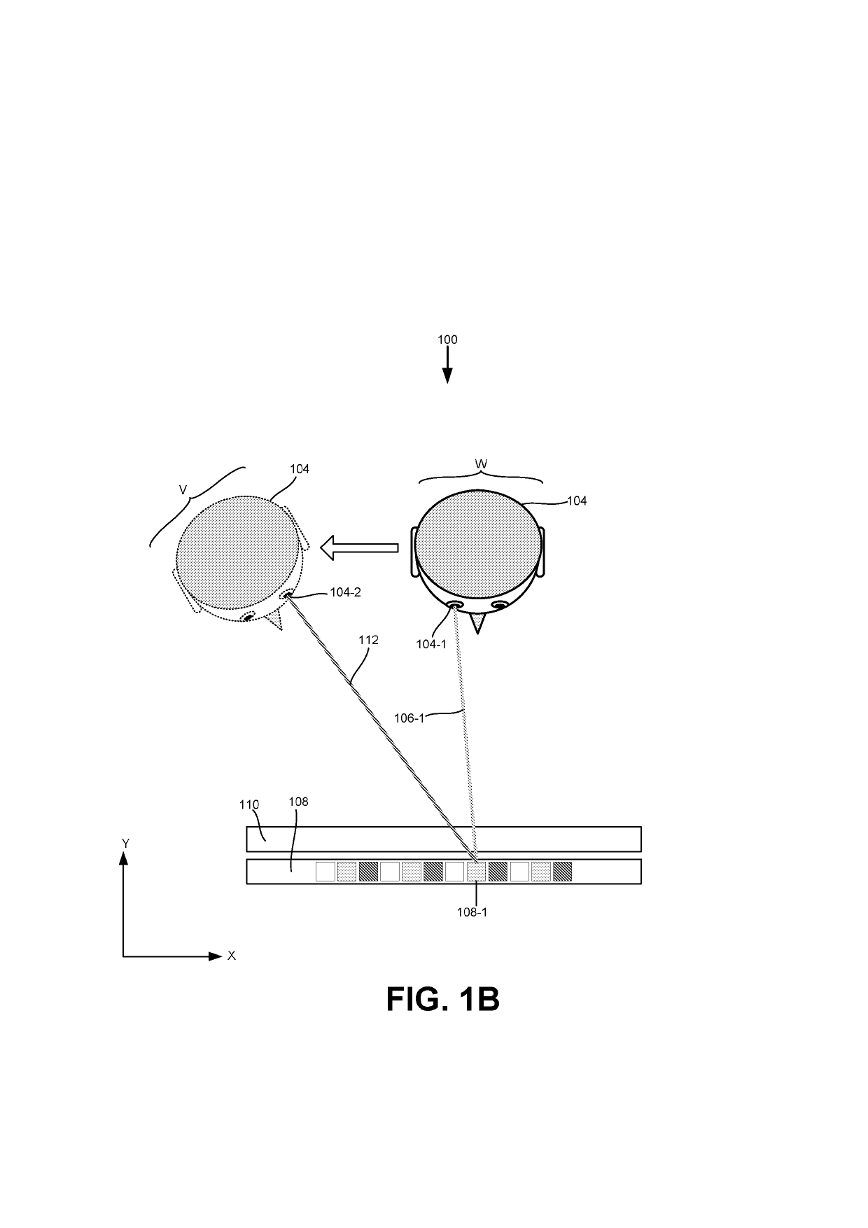

FIGS. 8A and 8B illustrate exemplary operation of the optical guide of the device of FIG. 1A according to yet another embodiment;

FIGS. 9A and 9B illustrate exemplary operation of the optical guide of the device of FIG. 1A according to still yet another embodiment; and

FIG. 10 is a flow diagram of an exemplary process for eliminating pseudo-stereoscopic images by the device of FIG. 1A.

### DETAILED DESCRIPTION

The following detailed description refers to the accompanying drawings. The same reference numbers in different drawings may identify the same or similar elements. In addition, the terms “viewer” and “user” are used interchangeably.

### Overview

Aspects described herein provide a visual three-dimensional (3D) effect based on device tracking, viewer tracking, and controlling an optical guide. As further described below, the optical guide may be implemented and operated in different ways. FIG. 1A is a diagram of an exemplary 3D system 100 in which concepts described herein may be implemented. As shown, 3D system 100 may include a device 102 and a viewer 104. Device 102 may generate and provide two-dimensional (2D) or 3D images to viewer 104 via a display. When device 102 shows a 3D image, the right eye 104-1 and the left-eye 104-2 of viewer 104 may receive a right-eye image and a left-eye image via light rays 106-1 and 106-2 that emanate from device 102. Light rays 106-1 and 106-2 may carry different visual information, such that, together, they provide a stereoscopic image to viewer 104.

Device 102 may include a display 108 and optical guide 110. Display 108 may include picture elements (pixels) for displaying images for right eye 104-1 and left eye 104-2. In FIG. 1A, pixels 108-1 and 108-3 are part of right-eye images and pixels 108-2 and 108-4 are part of left-eye images. Optical guide 110 directs light rays from right-eye image pixels to right eye 104-1 and left-eye image pixels to left eye 104-2.

In FIG. 1A, device 102 may not radiate or transmit the left-eye image and the right-eye image in an isotropic manner. Accordingly, at certain locations, viewer 104 may receive the best-quality stereoscopic image that device 102 is capable of conveying. As used herein, the term “sweet spots” may refer to locations at which viewer 104 can perceive relatively high quality stereoscopic images. At other locations, viewer 104 may receive incoherent images. As used herein, the term “pseudo-stereoscopic image” may refer to the incoherent images.

In FIG. 1A, viewer 104's position or location relative to device 102 may change. For example, as shown, viewer 104 may change from position W to position V. The change in the relative position may result from viewer 104's movement (e.g., translation, rotation, etc.) or from device 102's movement (e.g., translation, rotation, etc.).

In FIG. 1A, when viewer 104 moves from W to V, optical guide 110 may change its configuration, to continue to guide light rays to right eye 104-1 and left eye 104-2 from corresponding right-eye and left-eye images, respectively, on display 108, such that viewer 104 continues to perceive 3D images. For example, when viewer 104 moves from position W to position V, optical guide 110 guides light rays 106-3 and 106-4 from pixels 108-3 and 108-4 to right eye 104-1 and left eye 104-2, respectively.

In another example, when viewer 104 moves from position W to position V, optical guide 110 prevents light rays from inappropriate or wrong image pixels from reaching right eye 104-1 and left eye 104-2. The light rays from the inappropriate image pixels may result in viewer 104's perception of a pseudo-stereoscopic image. This may interfere with viewer's perception of high quality 3D images.

FIG. 1B illustrates generation of a pseudo-stereoscopic image in 3D system 100. In FIG. 1B, when viewer 104 moves from W to V, viewer 104 may receive, on left eye 104-2, light rays (e.g., light ray 112) from right-eye image pixels (e.g., pixel 108-1). Similarly, although not shown, viewer 104 may receive, on right eye 104-1, light rays from left-eye image pixels. This may result in viewer 104 perceiving a pseudo-stereoscopic image.

In FIGS. 1A and 1B, device 102 may send appropriate right-eye and left eye images to right eye 104-1 and left eye 104-2, respectively, and eliminate or decrease the power associated with pseudo-stereoscopic image(s), by adjusting optical guide 110 based on viewer 104 tracking and device 102 tracking.

### Exemplary Device

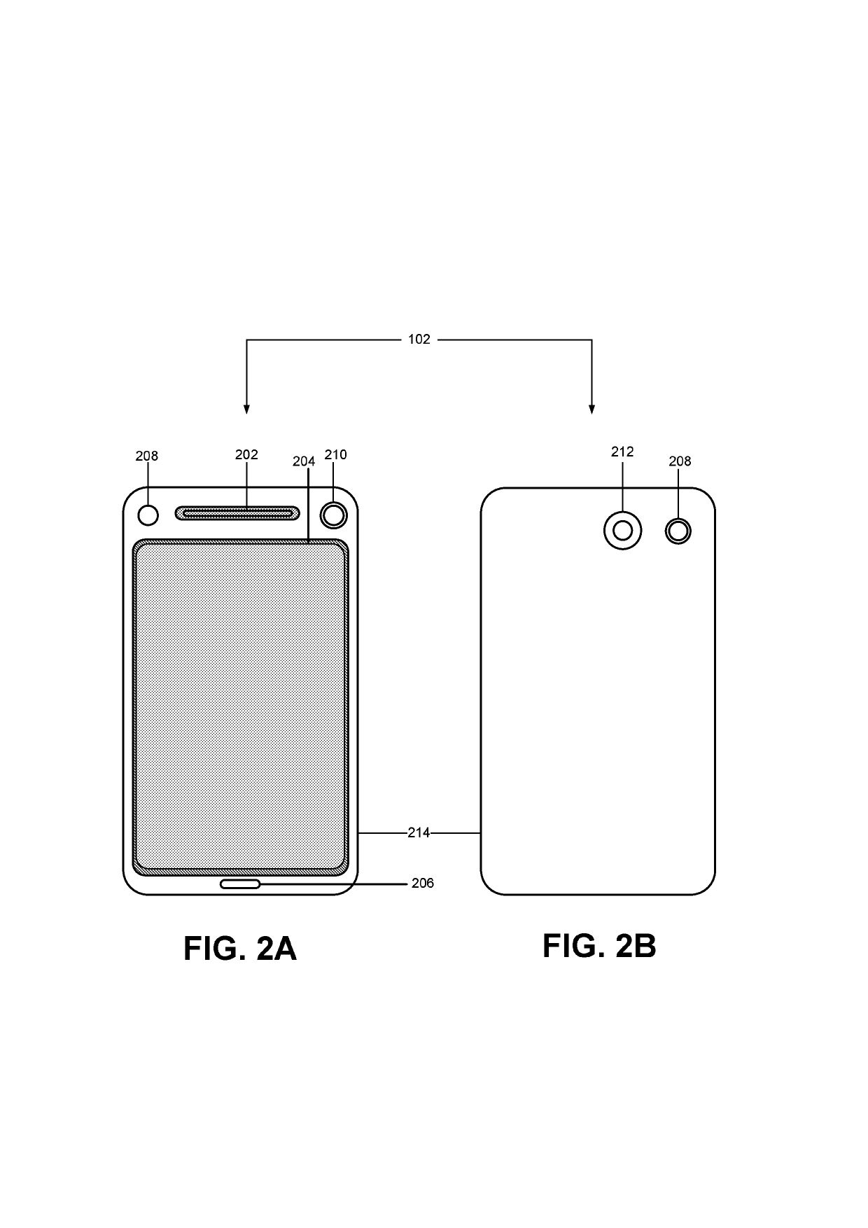

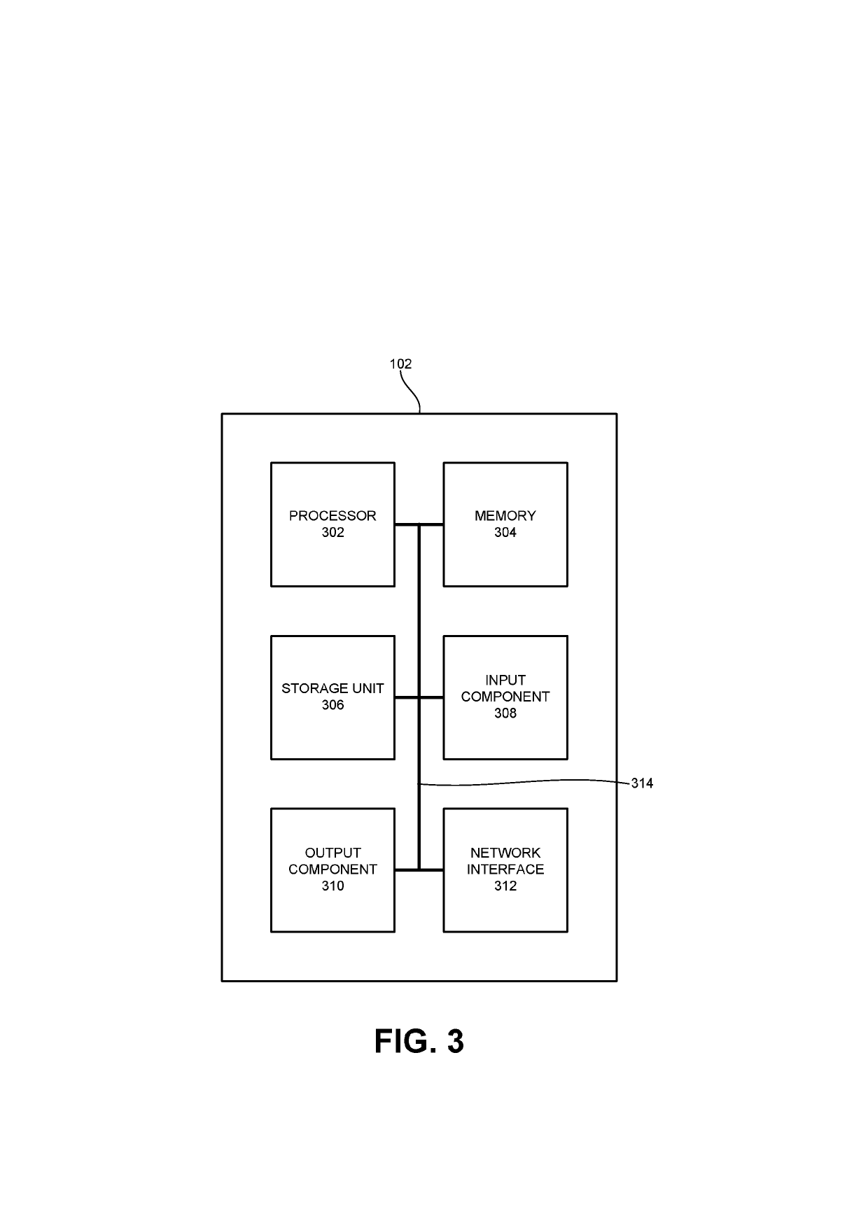

FIGS. 2A and 3B are front and rear views of one implementation of device 102. Device 102 may include any of the following devices that have the ability to or are adapted to display 2D and 3D images, such as a cell phone or a mobile telephone with a 3D display (e.g., smart phone); a tablet computer; an electronic notepad, a gaming console, a laptop, and/or a personal computer with a 3D display; a personal digital assistant (PDA) that can include a 3D display; a peripheral (e.g., wireless headphone, wireless display, etc.); a digital camera; or another type of computational or communication device with a 3D display, etc.

As shown in FIGS. 2A and 2B, device 102 may include a speaker 202, a 3D display 204, a microphone 206, sensors 208, a front camera 210, a rear camera 212, and housing 214. Speaker 202 may provide audible information to a user/viewer of device 102.

3D display 204 may provide two-dimensional or three-dimensional visual information to the user. Examples of 3D display 204 may include an auto-stereoscopic 3D display, a stereoscopic 3D display, a volumetric display, etc. 3D display 204 may include pixels that emit different light rays to viewer 104's right eye 104-1 and left eye 104-2, through optical guide 110 (FIGS. 1A and 1B) (e.g., a lenticular lens, a parallax barrier, etc.) that covers the surface of 3D display 204. In one implementation, optical guide 110 may dynamically change the directions in which the light rays are emitted from the surface of display 204, depending on input from device 102. In some implementations, 3D display 204 may also include a touch-screen, for receiving user input.

Microphone 206 may receive audible information from the user. Sensors 208 may collect and provide, to device 102, information pertaining to device 102 (e.g., movement, orientation, etc.), information that is used to aid viewer 104 in capturing images (e.g., for providing information for auto-focusing to front/rear cameras 210/212) and/or information tracking viewer 104 (e.g., proximity sensor). For example, sensor 208 may provide acceleration and orientation of device 102 to internal processors. In another example, sensors 208 may provide the distance and the direction of viewer 104 relative to device 102, so that device 102 can determine how to control optical guide 110. Examples of sensors 208 include an accelerometer, gyroscope, ultrasound sensor, an infrared sensor, a camera sensor, a heat sensor/detector, etc.

Front camera 210 and rear camera 212 may enable a user to view, capture, store, and process images of a subject located at the front/back of device 102. Front camera 210 may be separate from rear camera 212 that is located on the back of device 102. In some implementations, device 102 may include yet another camera at either the front or the back of device 102, to provide a pair of 3D cameras on either the front or the back. Housing 214 may provide a casing for components of device 102 and may protect the components from outside elements.

FIG. 3 is a block diagram of device 102. As shown, device 102 may include a processor 302, a memory 304, storage unit 306, input component 308, output component 310, a network interface 312, and a communication path 314. In different implementations, device 102 may include additional, fewer, or different components than the ones illustrated in FIG. 3.

Processor 302 may include a processor, a microprocessor, an Application Specific Integrated Circuit (ASIC), a Field Programmable Gate Array (FPGA), and/or other processing logic capable of controlling device 102. In one implementation, processor 302 may include components that are specifically designed to process 3D images. Memory 304 may include static memory, such as read only memory (ROM), and/or dynamic memory, such as random access memory (RAM), or onboard cache, for storing data and machine-readable instructions.

Storage unit 306 may include a magnetic and/or optical storage/recording medium. In some embodiments, storage unit 306 may be mounted under a directory tree or may be mapped to a drive. Depending on the context, the term “medium,” “memory,” “storage,” “storage device,” “storage medium,” and/or “storage unit” may be used interchangeably. For example, a “computer-readable storage device” or “computer readable storage medium” may refer to both a memory and/or storage device.

Input component 308 may permit a user to input information to device 102. Input component 308 may include, for example, a keyboard, a keypad, a mouse, a pen, a microphone, a touch screen, voice recognition and/or biometric mechanisms, sensors, etc. Output component 310 may output information to the user. Output component 310 may include, for example, a display, a printer, a speaker, etc.

Network interface 312 may include a transceiver that enables device 102 to communicate with other devices and/or systems. For example, network interface 312 may include mechanisms for communicating via a network, such as the Internet, a terrestrial wireless network (e.g., a WLAN), a satellite-based network, a personal area network (PAN), a WPAN, etc. Additionally or alternatively, network interface 312 may include a modem, an Ethernet interface to a LAN, and/or an interface/connection for connecting device 102 to other devices (e.g., a Bluetooth interface).

Communication path 314 may provide an interface through which components of device 102 can communicate with one another.

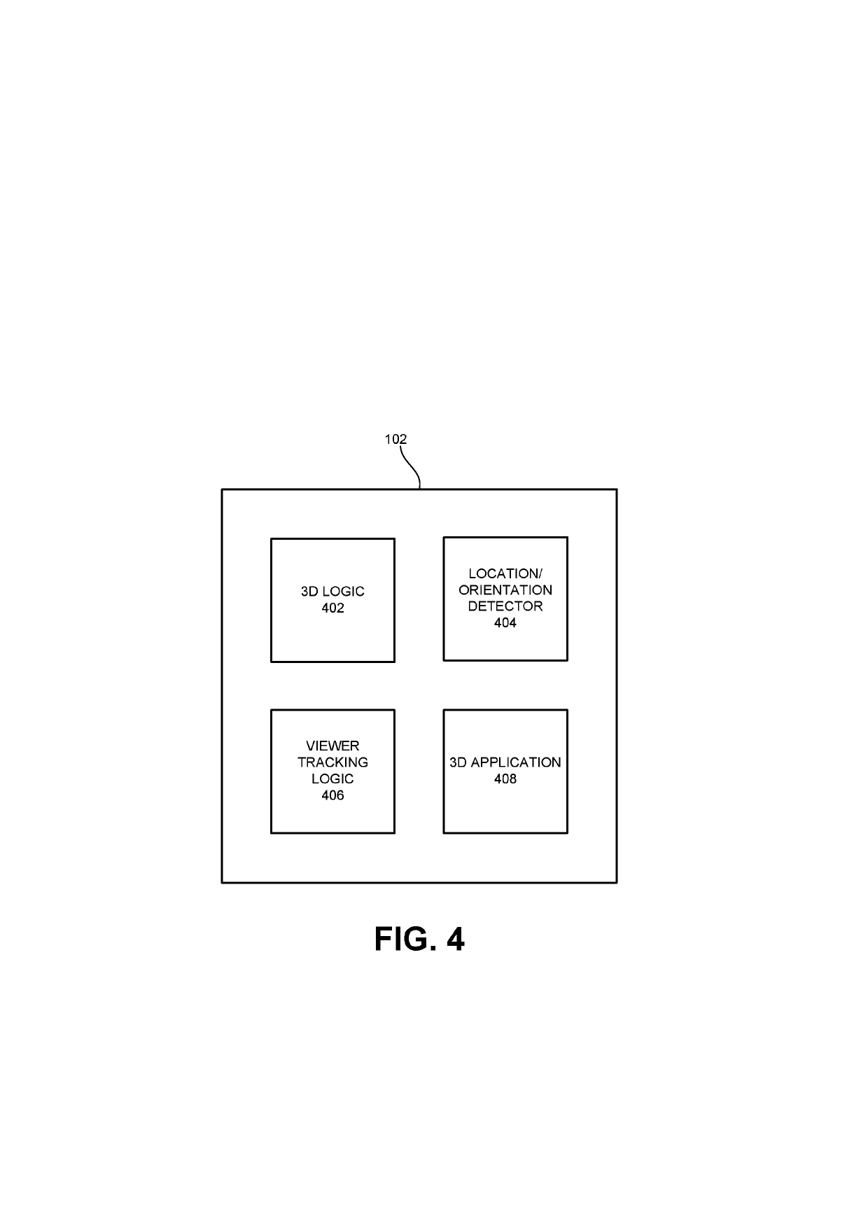

FIG. 4 is a functional block diagram of device 102. As shown, device 102 may include 3D logic 402, location/orientation detector 404, viewer tracking logic 406, and 3D application 408. Although not illustrated in FIG. 4, device 102 may include additional functional components, such as the components that are shown in FIG. 4, an operating system (e.g., Windows Mobile OS, Blackberry OS, Linux, Android, iOS, Windows Phone, etc.), an application (e.g., an instant messenger client, an email client, etc.), etc.

3D logic 402 may include hardware and/or software components for obtaining right-eye images and left-eye images and/or providing the right/left-eye images to a 3D display (e.g., display 204). In obtaining the right-eye and left-eye images, 3D logic 402 may receive right- and left-eye images from stored media content (e.g., a 3D movie). In other implementations, 3D logic 402 may generate the right and left-eye images of a 3D model or object for different pixels or sub-pixels. In such instances, device 102 may obtain projections of the 3D object onto 3D display 108.

In some implementations, 3D logic 402 may receive viewer input for selecting a sweet spot. In one implementation, when a viewer selects a sweet spot (e.g., by pressing a button on device 102), device 102 may store values of control variables that characterize optical guide 110, the location/orientation of user device 102, and/or the relative location of viewer 104. In another implementation, when the user selects a sweet spot, device 102 may recalibrate optical guide 110 such that the stereoscopic images are sent to the selected spot. In either case, as the viewer's relative location moves away from the established sweet spot, 3D logic 402 may determine (e.g., calculate) new directions to which light rays must be guided via optical guide 110.

In some implementations, the orientation of device 102 may affect the relative location of sweet spots. Accordingly, making proper adjustments to the angles at which the light rays from device 102 are directed, via optical guide 110, may be used in locking the sweet spot for viewer 104. The adjustments may be useful, for example, when device 102 is relatively unstable (e.g., being held by a hand). As described below, depending on the implementation, 3D logic 402 may make different types of adjustments to optical guide 110.

Returning to FIG. 4, location/orientation logic 404 may determine the location/orientation of device 102 and provide location/orientation information to 3D logic 402, viewer tracking logic 406, and/or 3D application 408. In one implementation, location/orientation logic 404 may obtain the information from a Global Positioning System (GPS) receiver, gyroscope, accelerometer, etc. in device 102.

Viewer tracking logic 406 may include hardware and/or software (e.g., a range finder, proximity sensor, cameras, image detector, etc.) for tracking viewer 104 and/or part of viewer 104 (e.g., head, eyes, etc.) and providing the location/position of viewer 104 to 3D logic 402. In some implementations, viewer tracking logic 406 may include sensors (e.g., sensors 208) and/or logic for determining a location of viewer 104's head or eyes based on sensor inputs (e.g., distance information from sensors, an image of a face, an image of eyes 104-1 and 104-2 from cameras, etc.).

3D application 408 may include hardware and/or software that shows 3D images on display 108. In showing the 3D images, 3D application 408 may use 3D logic 402, location/orientation detector 404, and/or viewer tracking logic 406 to generate 3D images and/or provide the 3D images to display 108. Examples of 3D application 408 may include a 3D graphics game, a 3D movie player, etc.

FIGS. 5A and 5B illustrate exemplary operation of optical guide 110 according to one embodiment. In this embodiment, optical guide 110 may include multiple optical elements that move in unison or are synchronized. For example, optical guide 110 may be implemented as a parallax barrier that includes multiple parallax barrier elements, one of which is shown as barrier element 504. The barrier elements may uniformly translate in x- or y-direction, rotate, etc.

For example, in one implementation, as shown, optical guide 110 may be coupled to a displacement unit 506. Displacement unit 506 may move optical guide 110 in the positive or negative x-direction relative to display 108, in accordance with control signal from 3D logic 402, resulting in uniform translation of the individual parallax barrier elements. The control signal may indicate the direction and the amount of displacement.

When in operation, 3D logic 402 may determine, based on the current position of optical guide 110 (i.e., the parallax barrier) relative to display 108 and viewer 104's location, whether light rays from particular pixels generate pseudo-stereoscopic images at viewer 104's location. In such cases, 3D logic 402 may determine the distance by which the barrier elements need to be displaced relative to display 108 to sufficiently block the light rays from the particular image pixels, while allowing enough light rays from correct image pixels.

For example, in FIG. 5A, pixel 108-1 transmits light rays 106-1 to right eye 104-1 of viewer 104 at location W. When viewer 104 moves to location V, 3D logic 402 determines that left eye 104-2 of viewer 104 at V would receive light rays 112 from pixel 108-1, which is the wrong or inappropriate image pixel for left eye 104-2. Based on viewer's new location V and the position of the parallax barrier relative to display 108, 3D logic 402 determines the direction and the amount of displacement for the parallax barrier, to prevent light ray 112 from reaching left eye 104-2 of viewer 104. 3D logic 402 sends a control signal to displacement unit 506, which then moves the parallax barrier.

FIG. 5B shows the initial and the end positions of optical guide 110. As shown, before displacement unit 506 moves optical guide 110, optical guide extends from A to B. After displacement unit 506 moves optical guide 110 in the direction indicated by the arrow 508, optical guide 110 extends from C to D. As shown, after the movement, parallax barrier element 504 blocks light ray 112 from reaching left eye 104-2 of viewer 104.

FIGS. 6A and 6B illustrate exemplary operation of optical guide 110 according to another embodiment. In this embodiment, optical guide 110 may include multiple optical elements that may be controlled individually. For example, the parallax barrier of FIGS. 6A and 6B may include individually controllable (e.g., translatable, rotatable, etc.) micro-electro-mechanical system (MEMS) parallax barrier elements, one of which is shown as parallax barrier element 604.

When in operation, 3D logic 402 may determine, based on the current positions of individual parallax barrier elements relative to display 108 and viewer 104's location, light rays from which pixels generate pseudo-stereoscopic images at viewer 104 location. In addition, 3D logic 402 may determine, for each parallax barrier element, a value of a control variable. In this implementation, the control variable may include the distance by which the parallax barrier element is to be displaced, relative to display 108, to block the light rays from the wrong image pixels, while allowing light rays from the appropriate or correct image pixels to reach viewer 104.

In FIG. 6A, just after viewer 104 moves to V, light ray 112 from pixel 108-1 is shown as emanating from display 108. In FIG. 6B, 3D logic 402 translates parallax barrier element 604 in x-direction, and prevents light ray 112 from reaching viewer 104.

In the embodiments illustrated in FIGS. 5A and 5B and FIGS. 6A and 6B, optical elements (e.g., parallax barrier elements) are illustrated as capable of translating, either synchronously as a group or independently from other barrier elements, relative to display 108. In other embodiments, the optical elements may be capable of other types of movements in optical guide 110, individually or as a group.

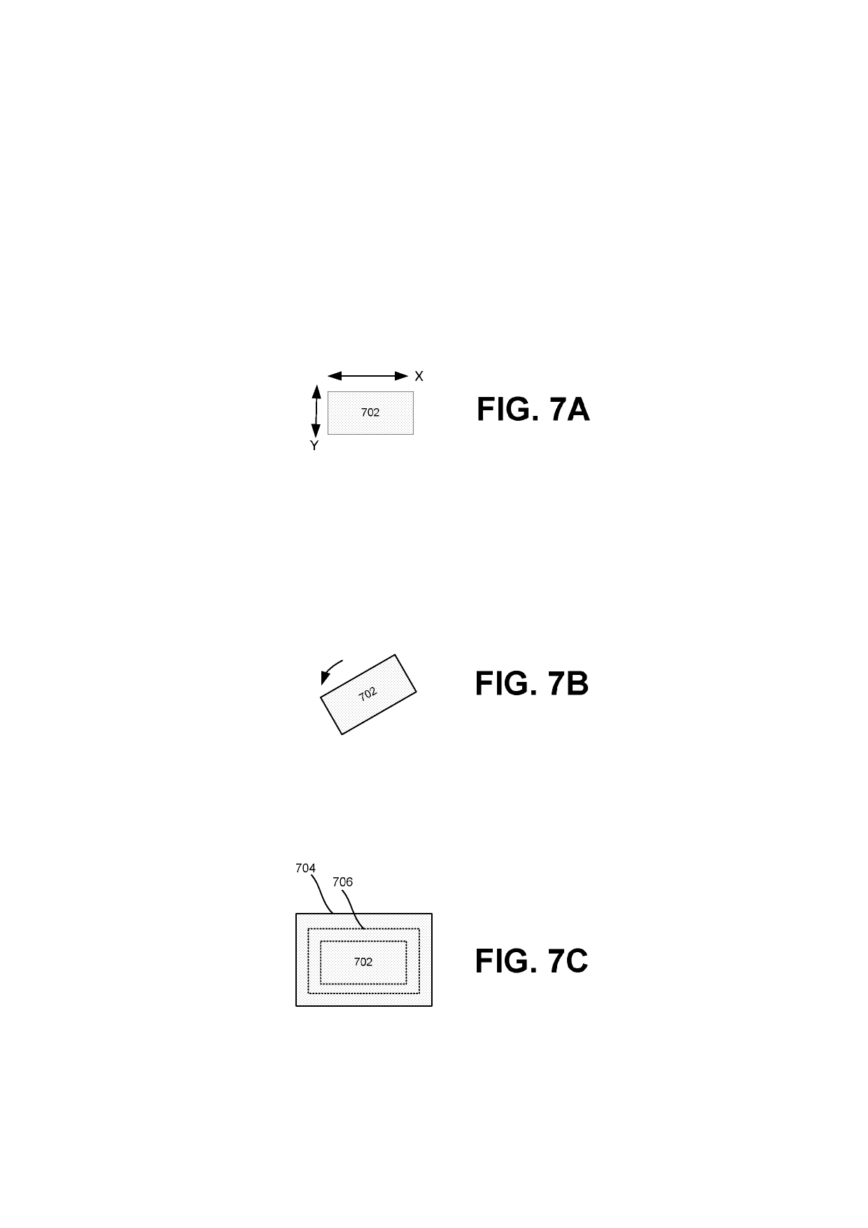

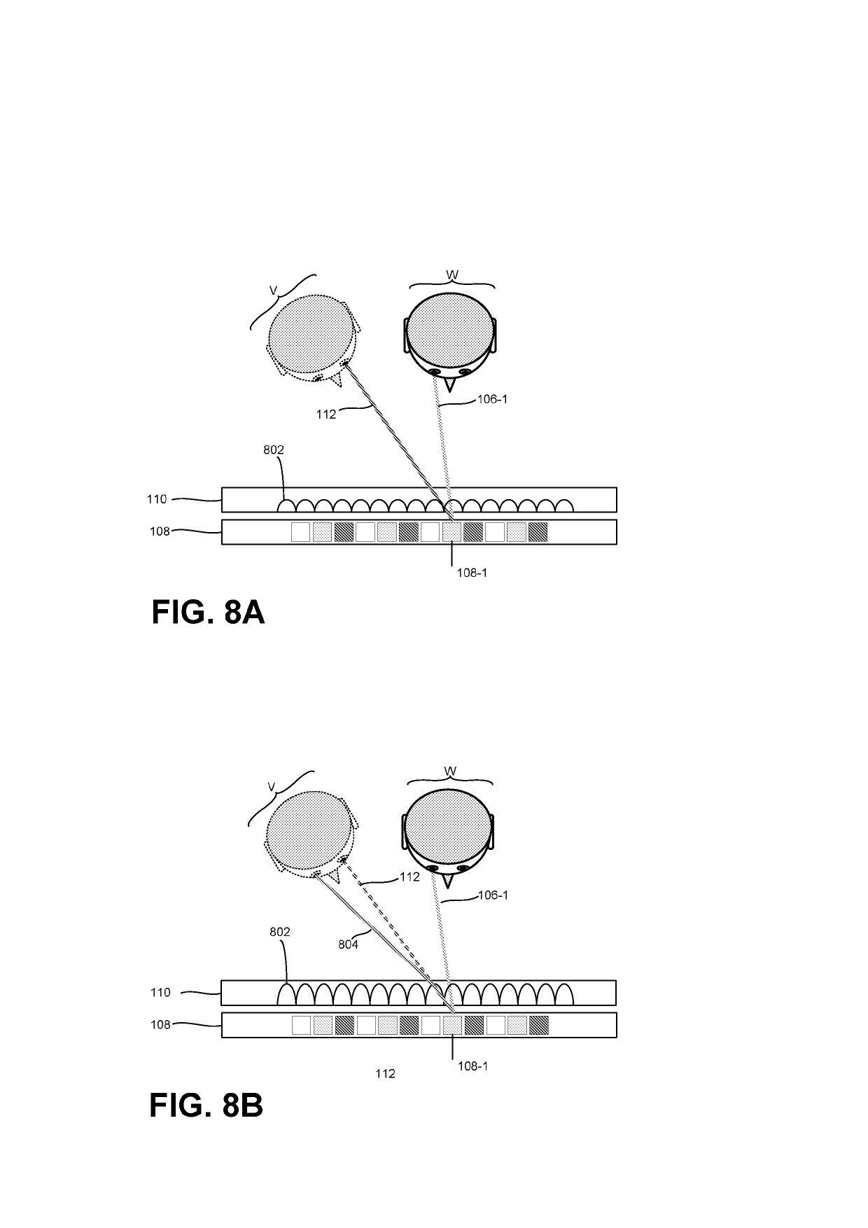

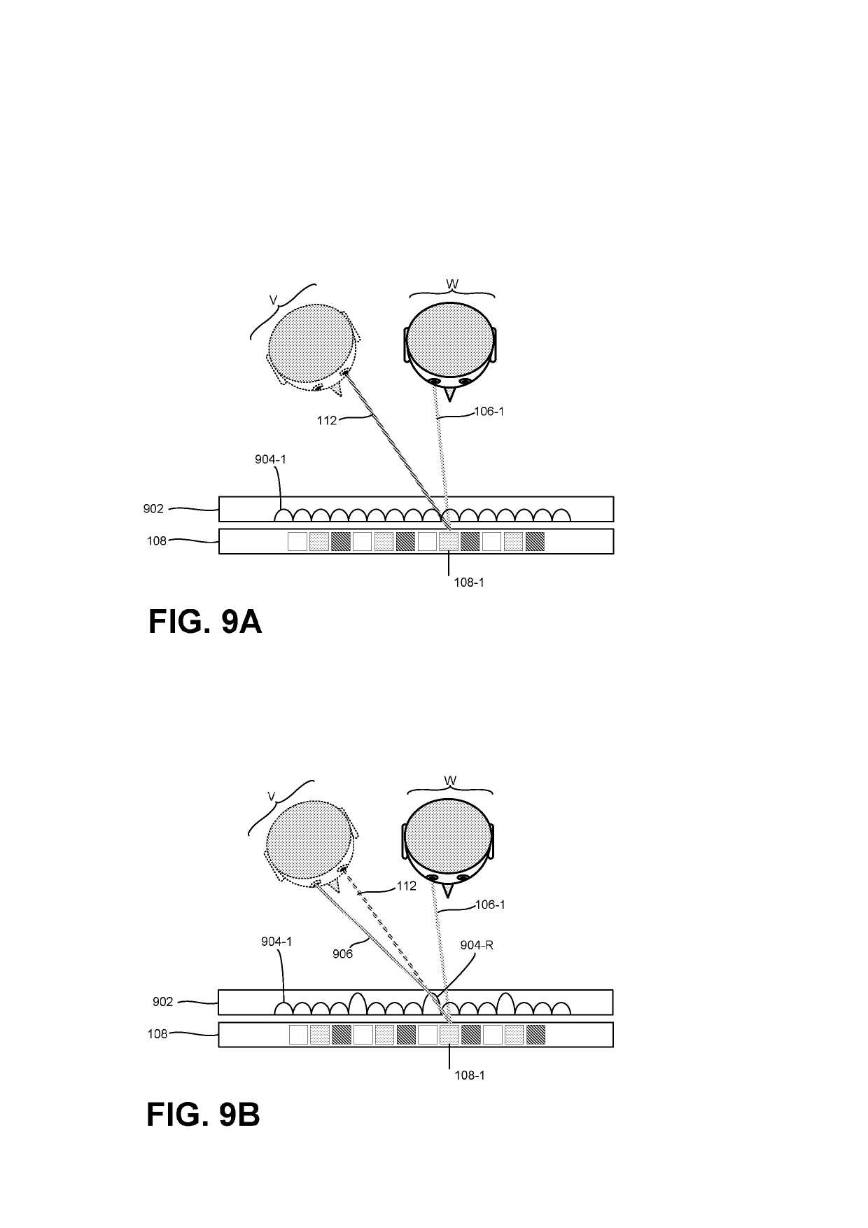

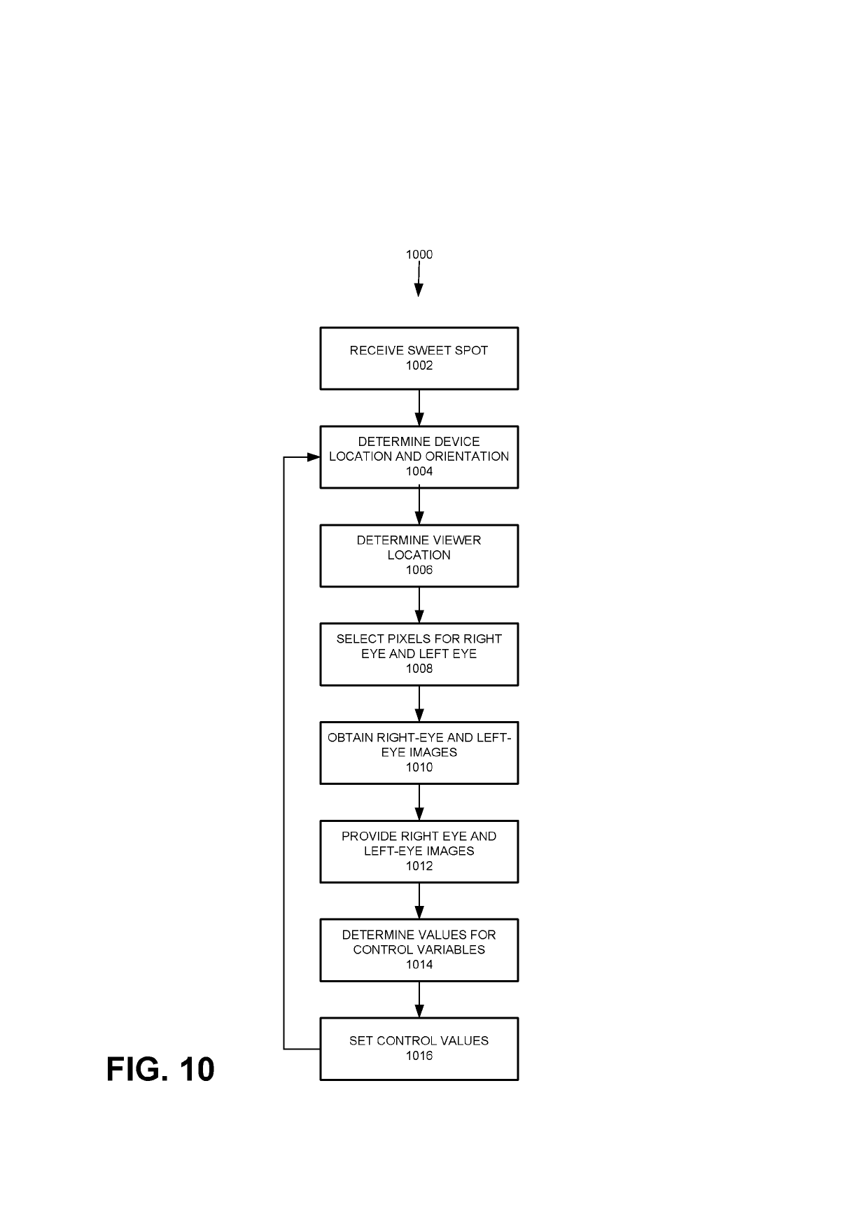

FIGS. 7A through 7C illustrate possible ways in which an optical element 702 (which may correspond to one of optical elements 504 or 604 in FIGS. 5A, 5B, 6A, and 6B) may move (e.g., via MEMS) and block or pass light rays from display 108. In one implementation, as shown in FIG. 7A, optical element 702 may move in x-direction or y-direction. In another implementation, as shown in FIG. 7B, optical element 702 may rotate. In yet another implementation, as shown in FIG. 7C, optical element 702 may expand to contract (e.g., due to heat, voltage, etc.). In these implementations, physical movements of the optical elements may determine whether particular light rays are prevented from reaching viewer 104. Furthermore, 3D logic 402 may control the physical movements by setting control variables that are associated with the movements (e.g., angle, distance, etc.).

Although the optical elements in FIGS. 5A, 5B, 6A and 6B are shown as parallax barrier elements, in other implementations, the optical elements may include other types of components, such as lenticular lens element, a prism element, a grating element, etc. These elements may move synchronously as a group in optical guide 108, as described above with reference to FIG. 5A or 5B, or alternatively, individually and independently from other optical elements, as described above with reference to FIGS. 6A and 6B.

FIGS. 8A and 8B illustrate exemplary operation of optical guide 110 according to yet another embodiment. In this embodiment, optical guide 110 may include optical elements that change their optical properties synchronously in optical guide 110. For example, optical guide 110 may be implemented as a lenticular lens 802 that includes multiple lenticular lens elements. The lenticular lens elements may uniformly change their optical properties in optical guide 110. For example, in one implementation, as shown, optical guide 110 may be coupled to a 3D logic 402 that sets values of control variables for setting physical curvature of individual lenticular lens elements, index of refraction, and/or another optical property.

When in operation, 3D logic 402 may determine, based on the current optical properties of lenticular lens 802 (i.e., index of refraction, the curvature of each lens element, etc.) and viewer 104's location, whether light rays from the pixels generate pseudo-stereoscopic image. In such cases, 3D logic 402 may determine the extent by which the optical properties of lenticular lens 802 may be modified to sufficiently deflect the light rays from the pixels that generate pseudo-stereoscopic images, while allowing enough light rays from the correct image pixels to pass to viewer 104.

For example, in FIG. 8A, pixel 108-1 transmits light rays 108-1 to right eye 104-1 of viewer 104 at W. As in FIG. 5A, when viewer 104 moves to V, 3D logic 402 determines that left eye 104-2 of viewer 104 at V would receive light rays 112 from pixel 108-1, which is the wrong image pixel for left eye 104-2. Based on viewer 104's new location V and the optical properties of lenticular lens 802, 3D logic 402 determines the extent by which the control variables must change, in order to change the optical properties and prevent enough of light rays 112 from reaching left eye 104-2 of viewer 104. 3D logic 402 sends a control signal to lenticular lens 802, changing its optical properties (i.e., change values of its control variables).

FIG. 8B shows the effect of changing the optical properties of optical guide 110. In FIG. 8B, lenticular lens elements are shown as being taller than those in FIG. 8A, indicating that their optical properties have changed. Due to the change, light rays 112 (shown in dotted line) are deflected, resulting in light rays 804. Hence, light rays 112 are prevented from reaching left eye 104-2 of viewer 104.

FIGS. 9A and 9B illustrate exemplary operation of optical guide 110 according to still yet another embodiment. In this embodiment, optical guide 110 may include multiple light guiding elements that may be controlled individually and independently from one another. For example, lenticular lens elements 904 of FIGS. 9A and 9B may be individually controllable (e.g., change its optical properties, such as its index of refraction).

When in operation, 3D logic 402 may determine or identify, based on the current optical properties of individual lenticular lens elements, relative to reference optical properties and viewer 104 location, which pixels generate light rays that contribute to pseudo-stereoscopic image(s) at viewer 104's location. In addition, 3D logic 402 may determine values of control variables to change optical properties of each of the lenticular lens elements, to prevent the light rays from the wrong or inappropriate image pixels from reaching viewer 104, while allowing light rays from the correct image pixels to reach viewer 104.

In FIG. 9A, just after viewer 104 moves to V, light ray 112 from pixel 108-1 is shown as emanating from display 108. In FIG. 9B, 3D logic 402 changes the optical properties of lenticular lens element 904-R, to produce deflected light ray 906. Hence, light ray 112 is prevented from reaching left eye 104-2 of viewer 104.

Although the optical elements in FIGS. 8A, 8B, 9A and 9B are shown as lenticular lens elements, in other implementations, the optical elements may include other types of components, such as a prism element, grating element, etc. These elements may change their optical properties in response to control signals from 3D logic 402, either synchronously in optical guide 108, as described above with reference to FIGS. 8A and 8B, or alternatively, individually, as described above with reference to FIGS. 9A and 9B.

### Exemplary Process for Eliminating Pseudo-Stereoscopic Images Based on Viewer/Device Tracking

FIG. 10 is a flow diagram of an exemplary process 1000 for eliminating pseudo-stereoscopic images by device 102, based on tracking device 102 and/or viewer 104. Assume that 3D logic 402 and/or 3D application 408 is executing on device 102. Process 1000 may include receiving a viewer input for selecting a sweet spot (block 1002). For example, viewer 104 may indicate that viewer 104 is in a sweet spot by pressing a button on device 102, touching a soft switch on display 204 of device 102, etc. In response to the viewer input, 3D logic 402/3D application 408 may store the values of control variables (e.g., angles at which optical guide 110 or the optical elements are sending light rays from pixels, the location/orientation of device 102, the relative location of viewer 104 or part of viewer 104's body (e.g., viewer 104's head, viewer 104's eyes, etc.), identities of pixels that are sending images to the right eye and of pixels that are sending images to the left eye, etc.). In some implementations, block 1002 may be omitted, as sweet spots for device 102 may be pre-configured.

Device 102 may determine device 102 location and/or orientation (block 1004). In one implementation, device 102 may obtain its location and orientation from location/orientation detector 404 (e.g., information from GPS receiver, gyroscope, accelerometer, etc.).

Device 102 may determine viewer 104's location (block 1006). Depending on the implementation, device 102 may determine viewer 104 location in one of several ways. For example, in one implementation, device 102 may use a proximity sensor (e.g., sensors 208) to locate viewer 104 (e.g., distance from the viewer to device 102/display 108 and an angle (e.g., measured normal to display 108). In another implementation, device 102 may sample images of viewer 104 (e.g., via camera 210 or 212) and perform object detection (e.g., to locate the viewer's eyes, to determine the distance between the eyes, to recognize the face, tilt of the viewer, etc.). Such information may be used to determine stereoscopic images and pseudo-stereoscopic images (projected from display 108) at right eye 104-1 and left eye 104-2 of viewer 104.

Device 102 may select or determine pixels, on display 108, that are configured to convey right-eye images to right eye 104-1 (i.e., right-eye image pixels) and pixels, on display 108, that are configured to convey left-eye images to left eye 104-2 (i.e., left-eye image pixels) (block 1008). Depending on the implementation, the left- and right-eye image pixels may already be set, or alternatively, device 102 may dynamically determine the right-eye image pixels and left-eye image pixels.

Device 102 may obtain right-eye and left-eye images (block 1010). For example, in one implementation, 3D application 408 may obtain right-eye and left-eye images from a media stream from a content provider over a network. In another implementation, 3D application 408 may generate the images from a 3D model or object based on viewer 104's relative location from display 108 or device 102.

Device 102 may provide the right-eye image and the left-eye image to the selected right- and left-eye pixels (block 1012). Furthermore, device 102 may determine values for control variables for each optical element in optical guide 110, based on viewer 104 tracking (e.g., tracking viewer 104's eyes, head, etc.) and device 102 tracking, to dynamically configure optical guide 110 (block 1014). In implementations where optical elements are controlled synchronously, device 102 may determine one set of values for the control variables for optical guide 110 (e.g., FIG. 5A and FIG. 8A), rather than for each optical element (e.g., FIG. 6A and FIG. 9A).

Each determined values of the control variables may reflect, for viewer 104, strength or power of stereoscopic image relative to that of pseudo-stereoscopic image. For example, in some implementations, device 102 may translate one or more parallax barrier elements or change optical properties of lenticular lens elements, to obtain a particular ratio (e.g., a value greater than a threshold) of the stereoscopic image power to pseudo-stereoscopic image power (e.g., a maximum value).

Depending on the implementation, 3D logic 402 may use different approaches to determine the values of control variables for optical guide 110. In some implementations, 3D logic 402 may access a function whose evaluation entails operation of a hardware component, execution of a software program, or look up of a table. In one implementation, the function may accept viewer 104's relative location and/or an optical element identifier as input or arguments and may output the values of the relative strengths of pseudo-stereoscopic image and stereoscopic image. In another implementation, the function may accept viewer 104's relative location and/or an optical element identifier as input/arguments and may output the values of control variables to set the relative displacement of the optical element, the index of refraction of the optical element, or any other control variables of optical guide 110 or an optical element.

When the function is implemented as a table, 3D logic 402 may look up the control values (i.e., values of the control variables) based on viewer's location relative to display 110, an optical element identifier, etc. Evaluating the function can be fast, since the values of the table are pre-computed (e.g., based on ratios of power contributed via an optical element in forming a stereoscopic image to power contributed via the optical element in forming pseudo-stereoscopic images). In some implementations, if optical elements in optical guide 110 are to be controlled as a group, the function may accept viewer 104's location as input, without an identifier for a particular optical element.

Device 102 may set the values of control variables for each of the optical elements (block 1016). In implementations where the optical elements are synchronized, there may be only one set of values for the control variables, rather than one set for each optical element. Setting the control values may send the light rays from a right-eye image to right eye 104-1 and a left-eye image to left eye 104-2.

In some implementations, device 102 may time multiplex left-eye images and right-eye images via the same set of pixels. (e.g., send a right-eye image to a set of pixels for a brief interval and send a left-eye image to the same set of pixels for the following interval). In these implementations, device may control the optical elements, to send a right-eye image from display 108 to right-eye 104-1 when the right-eye image is on display 108 and to send a left eye-image from display 108 to left-eye 104-2 when the left-eye image is on display 108.

In some implementations, the number of viewers that device 102 can support with respect to displaying 3D images may be greater than one (i.e., more than one viewer can see 3D images on display 108 at the same time). In such instances, some pixels may send images for the right eye of a first viewer, some pixels may send images to the left eye of the first viewer, some pixels may send images to the right eye of a second viewer, etc. Each optical element may guide light rays from each pixel to the right of left eye of a particular viewer based on location information associated with the viewers.

In other implementations, at least some of the pixels may multiplex images for multiple viewers. Device 102 may control the optical elements (i.e., change the control values), such that the optical elements guide light rays from each image on display 108 to a particular viewer/eyes.

### CONCLUSION

The foregoing description of implementations provides illustration, but is not intended to be exhaustive or to limit the implementations to the precise form disclosed. Modifications and variations are possible in light of the above teachings or may be acquired from practice of the teachings.

For example, in the above, device 102 may move optical elements via MEMS components. In other implementations, device 102 may move optical elements via other types of components, such as muscle wires, memory alloys (e.g., alloys that change shape and return to the shape), piezoelectric components (e.g., actuators), controllable polymers, etc.

In the above, while a series of blocks has been described with regard to exemplary processes 1000 illustrated in FIG. 10, the order of the blocks in processes 1000 may be modified in other implementations. In addition, non-dependent blocks may represent acts that can be performed in parallel to other blocks.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

It should be emphasized that the term “comprises/comprising” when used in this specification is taken to specify the presence of stated features, integers, steps or components but does not preclude the presence or addition of one or more other features, integers, steps, components, or groups thereof.

Further, certain portions of the implementations have been described as “logic” that performs one or more functions. This logic may include hardware, such as a processor, a microprocessor, an application specific integrated circuit, or a field programmable gate array, software, or a combination of hardware and software.

No element, act, or instruction used in the present application should be construed as critical or essential to the implementations described herein unless explicitly described as such. Also, as used herein, the article “a” is intended to include one or more items. Further, the phrase “based on” is intended to mean “based, at least in part, on” unless explicitly stated otherwise.

What is claimed is:

1. A method comprising:
determining a position of a user relative to a display of a device to obtain position information, wherein the device includes the display and an optical guide, wherein the display includes pixels for displaying images, and wherein the optical guide includes optical elements for directing light rays from the pixels;
selecting values for control variables associated with controlling the optical elements based on the position information;
displaying a stereoscopic image at the display;
controlling the optical elements to send light rays from the pixels of the display to convey the stereoscopic image to the position of the user and to prevent a pseudo-stereoscopic image from forming at the position of the user, by setting the control variables to the selected values.

2. The method of claim 1, wherein selecting the values includes:
for each of the optical elements, selecting a horizontal displacement, relative to the display, of the optical element; or
for the optical elements, selecting a horizontal displacement relative to the display.

3. The method of claim 2, wherein the optical elements include at least one of:
a parallax barrier element; a prism element; a grating element; or a lenticular lens element.

4. The method of claim 1, wherein selecting the values includes:
for each of the optical elements, selecting values for controlling micro-electromechanical system (MEMS) component, a muscle wire, memory alloys, a piezoelectric component, or controllable polymer to rotate or translate the optical element.

5. The method of claim 1, wherein selecting the values includes:
selecting values for setting optical properties of at least one of the optical elements; or
selecting a value for setting optical properties of the optical elements.

6. The method of claim 5, wherein each of the optical elements includes at least one of:
a parallax barrier element; a lenticular lens element; a prism element; or a grating element.

7. The method of claim 1, wherein the stereoscopic image includes a right-eye image and a left-eye image, and wherein controlling the optical elements includes:
directing the right-eye image to the right-eye of the user during a first time interval; and
directing the left-eye image to the left-eye of the user during a second time interval following the first time interval.

8. The method of claim 1, further comprising:
determining a second position of a second user relative to the display to obtain second position information;
displaying a second stereoscopic image at the display concurrently with the stereoscopic image; and
controlling the optical elements to send light rays from the pixels of the display to convey the second stereoscopic image to the second position of the second user.

9. The method of claim 1, wherein selecting the values includes:
determining values for the control variables associated with the optical elements to change relative power associated with the stereoscopic image in relation to power associated with the pseudo-stereoscopic image at the determined position of the user.

10. The method of claim 9, wherein determining the values includes:
evaluating a ratio of the power associated with the stereoscopic image to the power associated with the pseudo-stereoscopic image at the position of the user; or
looking up a table of values of the control variables, wherein the values are pre-computed based on ratios of the power associated with the stereoscopic image to the power associated with the pseudo-stereoscopic image.

11. The method of claim 10, wherein looking up includes identifying the values for the control variables based on the position of the user and an identifier associated with an optical element.

12. A device comprising:
sensors for obtaining tracking information associated with a user;
a display including pixels for displaying images;
an optical guide including optical elements, each of the optical elements directing light rays from one or more of the pixels; and
one or more processors to:
determine a relative location of the user based on the tracking information obtained by the sensors;
obtain values for control variables that are associated with the optical elements based on the relative location of the user;
display a stereoscopic image via the display; and
control the optical elements based on the values to direct the stereoscopic image to the relative location and to prevent a pseudo-stereoscopic image from forming at the relative location.

13. The device of claim 12, wherein the sensors include at least one of:
a gyroscope; a camera; a proximity sensor; or an accelerometer.

14. The device of claim 12, wherein the device includes:
a tablet computer; a cellular phone; a personal computer; a laptop computer; a camera; or a gaming console.

15. The device of claim 12, wherein the optical elements include at least one of:
a parallax barrier element; a lenticular lens element; a prism element; or a grating element.

16. The device of claim 12, wherein the control variables include at least one of:
an angle associated with one or more of the optical elements;
a horizontal or vertical displacement associated with one of the optical elements; or
a numerical value indicative of an optical property associated with one of the optical elements.

17. The device of claim 12, wherein the stereoscopic image includes a right eye image and a left-eye image at a right-eye position and a left-eye position that are associated with the relative location, respectively, and the pseudo-stereoscopic image includes one of a left-eye image or a right-eye image at the right-eye position and the left-eye position, respectively.

18. The device of claim 12, wherein when the one or more processors obtain the values for the control variables, the one or more processors are further configured to at least one of:
evaluate a ratio of power contributed via one of the optical elements in forming the stereoscopic image to power contributed via the one of the optical elements in forming the pseudo-stereoscopic image; or
perform a look up of a table of control values that are computed based on ratios, each ratio indicative of relative contributions, via one of the optical elements, to the stereoscopic images and the pseudo-stereoscopic image at the relative location.

19. The device of claim 12, wherein at least one of the optical elements includes a micro-electromechanical system (MEMS) component, a muscle wire, memory alloys, a piezoelectric component, or controllable polymer for modifying a location or orientation of the one of the optical elements.

20. A device comprising:
sensors for providing tracking information associated with a user;
a display including pixels;
a parallax barrier including parallax barrier elements, each of the parallax barrier elements for guiding light rays from one or more of the pixels to a right eye or a left eye of a user; and
one or more processors to:
determine a relative location of the user based on the tracking information;
obtain values of control variables for each of the parallax barrier elements based on the relative location of the right eye and the left eye;
display a stereoscopic image via the display, the stereoscopic image comprising a right-eye image and a left-eye image; and
change a displacement of the one or more of the parallax barrier elements relative to the display, based on the values to direct the right-eye image to the right eye and prevent light rays from the right-eye image from reaching the left eye.
